(19) United States
(12) Patent Application Publication
(10) Pub. No.: US 2024/0326810 A1
(43) Pub. Date: Oct. 3, 2024

(54) VEHICLE CONTROL DEVICE, VEHICLE CONTROL METHOD, AND NON-TRANSITORY RECORDING MEDIUM

(71) Applicant: TOYOTA JIDOSHA KABUSHIKI KAISHA, Toyota-shi Aichi-ken (JP)

(72) Inventor: Takashi Morimoto, Edogawa-ku Tokyo-to (JP)

(73) Assignee: TOYOTA JIDOSHA KABUSHIKI KAISHA, Toyota-shi Aichi-ken (JP)

(21) Appl. No.: 18/616,308

(22) Filed: Mar. 26, 2024

(30) Foreign Application Priority Data
Mar. 28, 2023 (JP) 2023-051970

(51) Int. Cl. B60W 30/16; B60W 60/00; G06V 10/70; G06V 20/58

(52) U.S. Cl. CPC B60W 30/16; B60W 60/001; G06V 10/70; G06V 20/58; B60W 2420/403; B60W 2554/802; G06V 2201/08

(57) ABSTRACT

A vehicle control device having a vehicle control part and a vehicle-to-vehicle distance estimation part estimating a vehicle-to-vehicle distance between a host vehicle and a preceding vehicle using a machine learning model based on an image including the preceding vehicle captured by a monocular camera mounted on the host vehicle, wherein the machine learning model is generated by performing machine learning using teacher data images including a preceding vehicle for learning captured from a vehicle for capturing teacher data images and annotation information added to the teacher data images, and the annotation information includes information showing any of the vehicle-to-vehicle distance between the vehicle for capturing teacher data images and the preceding vehicle for learning being suitable, the vehicle-to-vehicle distance being short, and the vehicle-to-vehicle distance being long.

### CROSS-REFERENCE TO RELATED APPLICATIONS

This application claims priority to Japanese Patent Application No. 2023-051970 filed Mar. 28, 2023, the entire contents of which are herein incorporated by reference.

### FIELD

The present disclosure relates to vehicle control device, vehicle control method, and non-transitory recording medium.

### BACKGROUND

PTL 1 (Japanese Unexamined Patent Publication No. 2019-008519) describes the art of detecting a moving body present in the surroundings of a vehicle and liable to obstruct traveling of the vehicle. In the art described in PTL 1, a recognition model is constructed by learning the types and positions of moving bodies for training included in images for training. An in-vehicle equipment detects the moving bodies based on recognition using the recognition model. Specifically, the recognition model is constructed using training data to which annotation information including coordinates of moving bodies for training included in images for training, type information showing the types of the moving bodies for training, and position information showing the positions at which moving bodies for training are present among a plurality of positions of sidewalks, roads, etc. included in the images for training is attached.

In the art described in PTL 1, the annotation information does not include information showing that a distance between a vehicle for training on which a camera capturing the images for training is mounted and a moving body for training (preceding vehicle for training) is a suitable vehicle-to-vehicle distance. For this reason, in the art described in PTL 1, a recognizer using a recognition model to recognize a preceding vehicle is not able to output result of recognition showing that the vehicle-to-vehicle distance between the preceding vehicle included in an image captured from a vehicle in which the recognizer is mounted and the vehicle is a suitable vehicle-to-vehicle distance based on the image.

Further, in the art described in PTL 1, the annotation information does not include information showing that the distance between the vehicle for training and the moving body for training is shorter than the suitable vehicle-to-vehicle distance. For this reason, in the art described in PTL 1, the recognizer cannot output result of recognition showing that the vehicle-to-vehicle distance between the preceding vehicle included in the image captured from the vehicle and the vehicle is shorter than the suitable vehicle-to-vehicle distance based on the image.

Furthermore, in the art described in PTL 1, the annotation information does not include information showing that the distance between the vehicle for training and the moving body for training is longer than the suitable vehicle-to-vehicle distance. For this reason, in the art described in PTL 1, the recognizer cannot output result of recognition showing that the vehicle-to-vehicle distance between the preceding vehicle included in the image captured from the vehicle and the vehicle is longer than the suitable vehicle-to-vehicle distance based on the image.

As a result, in the art described in PTL 1, it is not possible to maintain the vehicle-to-vehicle distance between the vehicle and the preceding vehicle at the suitable vehicle-to-vehicle distance based on result of recognition of the recognizer based on the image captured from the vehicle.

### SUMMARY

In consideration of the above-mentioned point, the present disclosure has as its object to provide vehicle control device, vehicle control method, and non-transitory recording medium able to maintain a vehicle-to-vehicle distance between a host vehicle and a preceding vehicle at a suitable vehicle-to-vehicle distance based on an image including the preceding vehicle captured by a monocular camera mounted on the host vehicle.

(1) One aspect of the present disclosure is a vehicle control device including a processor configured to: perform autonomous driving control of a host vehicle; and estimate a vehicle-to-vehicle distance of the host vehicle and a preceding vehicle by using machine learning model based on an image including the preceding vehicle captured by a monocular camera mounted on the host vehicle, wherein the machine learning model is generated by performing machine learning using teacher data images including a preceding vehicle for learning captured from a vehicle for capturing teacher data images and annotation information added to the teacher data images, the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance, the processor is configured to output result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance, and perform the autonomous driving control of the host vehicle based on the result of estimation.

(2) In the vehicle control device of the aspect (1), the processor may be configured to perform the autonomous driving control of the host vehicle so that the vehicle-to-vehicle distance of the host vehicle and the preceding vehicle becomes longer up to the suitable vehicle-to-vehicle distance when the result of estimation showing the vehicle-to-vehicle distance of the host vehicle and the preceding vehicle is shorter than the suitable vehicle-to-vehicle distance is output and the processor may be configured to perform the autonomous driving control of the host vehicle so that the vehicle-to-vehicle distance of the host vehicle and the preceding vehicle becomes shorter down to the suitable vehicle-to-vehicle distance when the result of estimation showing the vehicle-to-vehicle distance of the host vehicle and the preceding vehicle is longer than the suitable vehicle-to-vehicle distance is output.

(3) In the vehicle control device of the aspect (1) or (2), the preceding vehicle may be traveling in the same lane as a lane which the host vehicle is traveling in, and the preceding vehicle for learning may include a vehicle traveling in a different lane from a lane which the vehicle for capturing the teacher data images is traveling in.

(4) In the vehicle control device of any of the aspects (1) to (3), the annotation information may include information showing a type of the preceding vehicle for learning, and the annotation information may be added to a teacher data image when annotation of the teacher data image is performed.

(5) Another aspect of the present disclosure is a vehicle control method including: performing autonomous driving control of a host vehicle; and estimating a vehicle-to-vehicle distance of the host vehicle and a preceding vehicle by using machine learning model based on an image including the preceding vehicle captured by a monocular camera mounted on the host vehicle, wherein the machine learning model is generated by performing machine learning using teacher data images including a preceding vehicle for learning captured from a vehicle for capturing teacher data images and annotation information added to the teacher data images, the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance, in estimation of the vehicle-to-vehicle distance of the host vehicle and the preceding vehicle, result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance is output, and the autonomous driving control of the host vehicle is performed based on the result of estimation output in the estimation of the vehicle-to-vehicle distance of the host vehicle and the preceding vehicle.

(6) Still another aspect of the present disclosure is a non-transitory recording medium having recorded thereon a computer program for causing a processor to execute a process including: performing autonomous driving control of a host vehicle; and estimating a vehicle-to-vehicle distance of the host vehicle and a preceding vehicle by using machine learning model based on an image including the preceding vehicle captured by a monocular camera mounted on the host vehicle, wherein the machine learning model is generated by performing machine learning using teacher data images including a preceding vehicle for learning captured from a vehicle for capturing teacher data images and annotation information added to the teacher data images, the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance, in estimation of the vehicle-to-vehicle distance of the host vehicle and the preceding vehicle, result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance is output, and the autonomous driving control of the host vehicle is performed based on the result of estimation output in the estimation of the vehicle-to-vehicle distance of the host vehicle and the preceding vehicle.

According to the present disclosure, it is possible to maintain a vehicle-to-vehicle distance between a host vehicle and a preceding vehicle at a suitable vehicle-to-vehicle distance based on an image including the preceding vehicle captured by a monocular camera mounted on the host vehicle.

### BRIEF DESCRIPTION OF DRAWINGS

FIG. 1 shows one example of a host vehicle 1 to which a vehicle control device 12 of a first embodiment is applied.

FIG. 2 shows one example of a specific configuration of the vehicle control device 12 shown in FIG. 1.

FIG. 3 shows one example of an image including a preceding vehicle VL etc. captured by a monocular camera 2 mounted on the host vehicle 1.

FIG. 4 shows a first example of a teacher data image and annotation information added to the teacher data image used in machine learning of a machine learning model.

FIG. 5 shows a second example of the teacher data image and the annotation information added to the teacher data image used in the machine learning of the machine learning model.

FIG. 6 shows a third example of the teacher data image and the annotation information added to the teacher data image used in the machine learning of the machine learning model.

FIG. 7 shows another example of the image including the preceding vehicle VL etc. captured by the monocular camera 2 mounted on the host vehicle 1.

FIG. 8 shows still another example of the image including the preceding vehicle VL etc. captured by the monocular camera 2 mounted on the host vehicle 1.

FIG. 9 is a flow chart for explaining one example of processing performed by a processor 23.

### DESCRIPTION OF EMBODIMENTS

Below, referring to the drawings, embodiments of vehicle control device, vehicle control method, and non-transitory recording medium of the present disclosure will be explained.

### First Embodiment

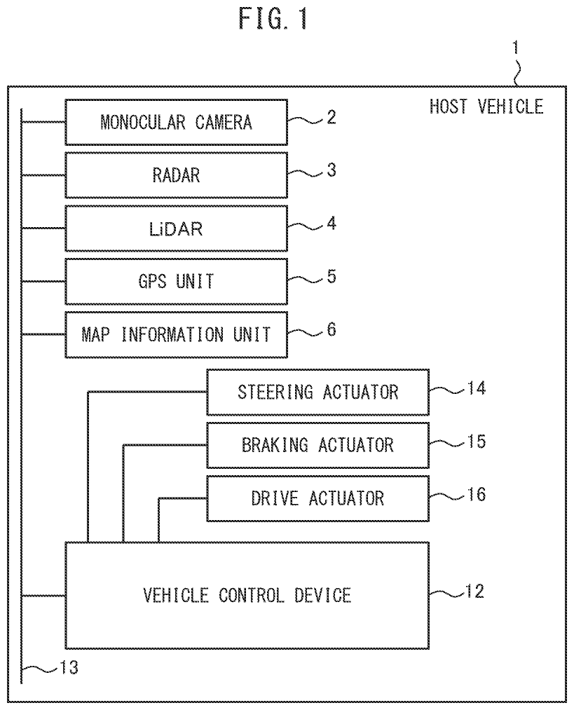

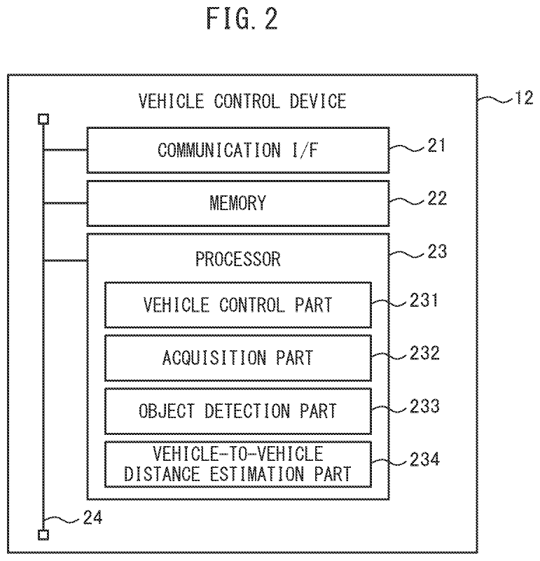

FIG. 1 shows one example of a host vehicle 1 to which a vehicle control device 12 of a first embodiment is applied. FIG. 2 shows one example of a specific configuration of the vehicle control device 12 shown in FIG. 1.

In the example shown in FIG. 1 and FIG. 2, the host vehicle 1 is provided with monocular camera 2, radar 3, LiDAR (Light Detection And Ranging) 4, and the vehicle control device 12. The monocular camera 2 captures an image including a preceding vehicle VL traveling in the same lane LI as the lane LI which the host vehicle 1 is traveling in and sends the image data to the vehicle control device 12.

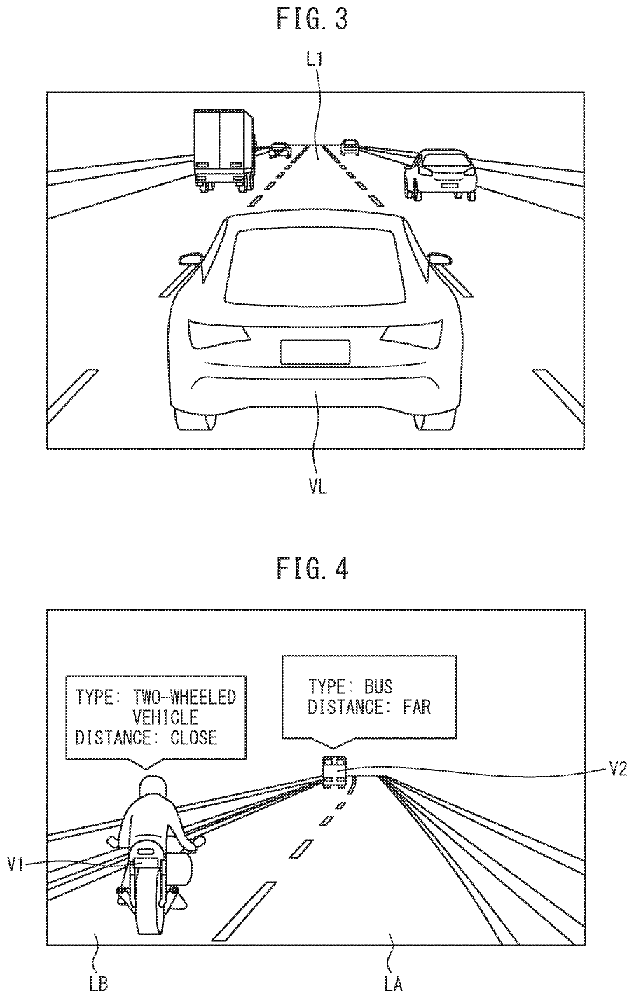

FIG. 3 shows one example of the image including the preceding vehicle VL etc. captured by the monocular camera 2 mounted on the host vehicle 1. In the example shown in FIG. 3, the preceding vehicle VL traveling in the same lane LI as the lane LI which the host vehicle 1 is traveling in is included in the image captured by the monocular camera 2.

In the example shown in FIG. 1 and FIG. 2, the radar 3 is, for example, a millimeter wave radar, 24 GHz band narrow band region radar, etc., detects the relative positions and relative speeds of nearby vehicles and road structure with respect to the host vehicle 1, and sends the results of detection to the vehicle control device 12. The LiDAR 4 detects the relative positions and relative speeds of the nearby vehicles and the road structure with respect to the host vehicle 1 and sends the results of detection to the vehicle control device 12.

Further, the host vehicle 1 is provided with GPS (global positioning system) unit 5 and map information unit 6. The GPS unit 5 acquires position information showing the current position of the host vehicle 1 based on the GPS signal and sends the position information of the host vehicle 1 to the vehicle control device 12. The map information unit 6 is, for example, formed in HDD (hard disk drive), SSD (solid state drive), or other storage mounted on the host vehicle 1. The map information of the map information unit 6 includes the road structure (position of the road, shape of the road, lane structure, etc.), rules, and various other information. The monocular camera 2, the radar 3, the LiDAR 4, the GPS unit 5, the map information unit 6, and the vehicle control device 12 are connected via an internal vehicle network 13.

Furthermore, the host vehicle 1 is provided with steering actuator 14, braking actuator 15, and drive actuator 16. The steering actuator 14 has the function of steering the host vehicle 1. The steering actuator 14, for example, includes power steering system, steer-by-wire steering system, rear wheel steering system, etc. The braking actuator 15 has the function of causing the host vehicle 1 to decelerate. The braking actuator 15 includes, for example, hydraulic brake, power regeneration brake, etc. The drive actuator 16 has the function of causing the host vehicle 1 to accelerate. The drive actuator 16, for example, includes engine, EV (electric vehicle) system, hybrid system, fuel cell system, etc.

In the example shown in FIG. 1 and FIG. 2, the vehicle control device 12 is configured by an autonomous driving ECU (electronic control unit). The vehicle control device 12 (autonomous driving ECU) is able to control the host vehicle 1 by a driving control level of the level 3 or more defined by the SAE (Society of Automotive Engineers), that is, a driving control level not requiring operation of the steering actuator 14, the braking actuator 15, and the drive actuator 16 and monitoring of the surroundings of the host vehicle 1 by the driver of the host vehicle 1. Furthermore, the vehicle control device 12 is able to control the host vehicle 1 by a driving control level at which the driver is involved in driving of the host vehicle 1.

The vehicle control device 12 is configured by a microcomputer provided with communication interface (I/F) 21, memory 22, and processor 23. The communication interface 21, the memory 22, and the processor 23 are connected via signal lines 24. The communication interface 21 has an interface circuit for connecting the vehicle control device 12 to the internal vehicle network 13. The memory 22 is one example of a storage part and, for example, has a volatile semiconductor memory and a nonvolatile semiconductor memory. The memory 22 stores programs used in processing performed by the processor 23 and various data. Further, the memory 22 stores the image data sent from the monocular camera 2, the results of detection of nearby vehicles etc. from the radar 3 and the LiDAR 4, a trained machine learning model generated at a machine learning model generating server (not shown) etc. and acquired by the vehicle control device 12, etc. The processor 23 has the function of a vehicle control part 231, the function of an acquisition part 232, the function of an object detection part 233, and the function of a vehicle-to-vehicle distance estimation part 234.

In the example shown in FIG. 1 and FIG. 2, the vehicle control device 12 is provided with a single processor 23, but in another example, the vehicle control device 12 may be provided with several processors. Further, in the example shown in FIG. 1 and FIG. 2, the vehicle control device 12 is configured by a single ECU (autonomous driving ECU), but in another example, the vehicle control device 12 may be configured by several ECUs.

In the example shown in FIG. 1 and FIG. 2, the vehicle control part 231 performs autonomous driving control of the host vehicle 1. The acquisition part 232 acquires the image data generated by the monocular camera 2, the results of detection of the radar 3, the results of detection of the LiDAR 4, etc.

The object detection part 233, for example, identifies the position and class (for example, category such as car, person, or the like) of an object included in the image captured by the monocular camera 2 such as shown in FIG. 3. The object detection part 233 performs object detection by using the trained machine learning model.

The vehicle-to-vehicle distance estimation part 234, for example, uses the trained machine learning model to thereby estimate the vehicle-to-vehicle distance between the host vehicle 1 and the preceding vehicle VL based on the image including preceding vehicles VL captured by the monocular camera 2 such as shown in FIG. 3.

The machine learning model is generated at, for example, the machine learning model generating server etc. by performing machine learning using teacher data images including preceding vehicles for learning-V1 to V9 (see FIG. 4 to FIG. 6) captured from a vehicle for capturing teacher data images (not shown) and annotation information added to the teacher data images. The annotation information is, for example, added to the teacher data images at the time of annotating the teacher data images in the machine learning model generating server etc.

The annotation information includes any of the information “distance: suitable” showing the vehicle-to-vehicle distance between the vehicle for capturing teacher data images and each of the preceding vehicles for learning V1 to V9 is the suitable vehicle-to-vehicle distance, the information “distance: close” showing the vehicle-to-vehicle distance between the vehicle for capturing teacher data images and each of the preceding vehicles for learning V1 to V9 is shorter than a suitable vehicle-to-vehicle distance, and the information “distance: far” showing the vehicle-to-vehicle distance between the vehicle for capturing teacher data images and each of the preceding vehicles for learning V1 to V9 is longer than a suitable vehicle-to-vehicle distance.

Further, the annotation information includes information showing the types of the preceding vehicles for learning V1 to V9 (for example, passenger vehicles, trucks, buses, light vehicles, two-wheeled vehicles, etc.)

FIG. 4 shows a first example of a teacher data image and the annotation information added to the teacher data image used in the machine learning of the machine learning model.

In the example shown in FIG. 4, the teacher data image is captured from the vehicle for capturing teacher data images traveling in the lane LA. The teacher data image includes preceding vehicles for learning V1 and V2 traveling in the lane LB different from the lane LA which the vehicle for capturing teacher data images is traveling in.

Further, the information “distance: close” showing that the vehicle-to-vehicle distance between the vehicle for capturing teacher data images and the preceding vehicle for learning V1 is shorter than the suitable vehicle-to-vehicle distance and the information “type: two-wheeled vehicle” showing the type of the preceding vehicle for learning V1 are added to the teacher data image as the annotation information.

Furthermore, the information “distance: far” showing that the vehicle-to-vehicle distance between the vehicle for capturing teacher data images and the preceding vehicle for learning V2 is longer than the suitable vehicle-to-vehicle distance and the information “type: bus” showing the type of the preceding vehicle for learning V2 are added to the teacher data image as the annotation information.

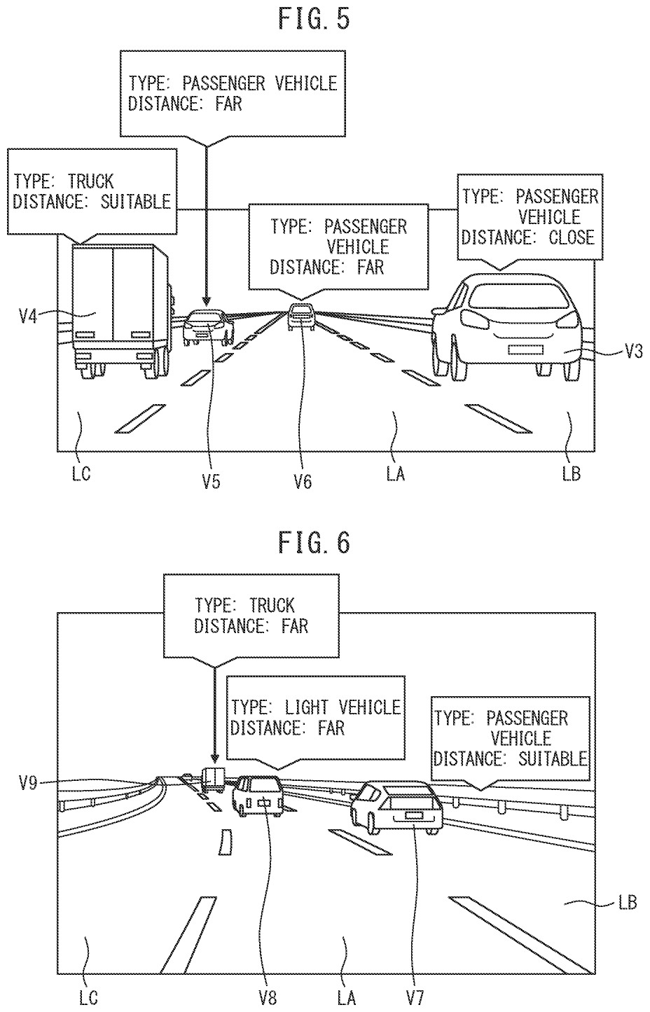

FIG. 5 shows a second example of the teacher data image and the annotation information added to the teacher data image used in the machine learning of the machine learning model.

In the example shown in FIG. 5, the teacher data image is captured from the vehicle for capturing teacher data images traveling in the lane LA. The teacher data image includes the preceding vehicle for learning V3 traveling in the lane LB different from the lane LA which the vehicle for capturing teacher data images is traveling in, the preceding vehicles for learning V4 and V5 traveling in the lane LC different from the lane LA which the vehicle for capturing teacher data images is traveling in, and the preceding vehicle for learning V6 traveling in the same lane as the lane LA which the vehicle for capturing teacher data images is traveling in.

Further, the information “distance: close” showing that the vehicle-to-vehicle distance between the vehicle for capturing teacher data images and the preceding vehicle for learning V3 is shorter than the suitable vehicle-to-vehicle distance, the information “type: passenger vehicle” showing the type of the preceding vehicle for learning V3, the information “distance: suitable” showing that the vehicle-to-vehicle distance between the vehicle for capturing teacher data images and the preceding vehicle for learning V4 is the suitable vehicle-to-vehicle distance, and the information “type: truck” showing the type of the preceding vehicle for learning V4 are added to the teacher data image as the annotation information.

Further, the information “distance: far” showing that the vehicle-to-vehicle distance between the vehicle for capturing teacher data images and the preceding vehicle for learning V5 is longer than the suitable vehicle-to-vehicle distance, the information “type: passenger vehicle” showing the type of the preceding vehicle for learning V5, the information “distance: far” showing that the vehicle-to-vehicle distance between the vehicle for capturing teacher data images and the preceding vehicle for learning V6 is longer than the suitable vehicle-to-vehicle distance, and the information “type: passenger vehicle” showing the type of the preceding vehicle for learning V6 are added to the teacher data image as the annotation information.

FIG. 6 shows a third example of the teacher data image and the annotation information added to the teacher data image used in the machine learning of the machine learning model.

In the example shown in FIG. 6, the teacher data image is captured from the vehicle for capturing teacher data images traveling in the lane LA. The teacher data image includes the preceding vehicle for learning V7 traveling in the lane LB different from the lane LA which the vehicle for capturing teacher data images is traveling in and the preceding vehicles for learning V8 and V9 traveling in the same lane as the lane LA which the vehicle for capturing teacher data images is traveling in.

Further, the information “distance: suitable” showing that the vehicle-to-vehicle distance between the vehicle for capturing teacher data images and the preceding vehicle for learning V7 is the suitable vehicle-to-vehicle distance and the information “type: passenger vehicle” showing the type of the preceding vehicle for learning V7 are added to the teacher data image as the annotation information.

Further, the information “distance: far” showing that the vehicle-to-vehicle distance between the vehicle for capturing teacher data images and the preceding vehicle for learning V8 is longer than the suitable vehicle-to-vehicle distance, the information “type: light vehicle” showing the type of the preceding vehicle for learning V8, the information “distance: far” showing that the vehicle-to-vehicle distance between the vehicle for capturing teacher data images and the preceding vehicle for learning V9 is longer than the suitable vehicle-to-vehicle distance, and information “type: truck” showing the type of the preceding vehicle for learning V9 are added to the teacher data image as the annotation information.

As explained above, for example, the machine learning model generating server etc. generates the trained machine learning model using teacher data images such as shown in FIG. 4 to FIG. 6 and the annotation information added to the teacher data images.

Further, as explained above, the vehicle control device 12 acquires the trained machine learning model generated at the machine learning model generating server etc., and the memory 22 of the vehicle control device 12 stores the trained machine learning model.

Furthermore, as explained above, the object detection part 233 of the vehicle control device 12 uses the trained machine learning model to perform object recognition. Specifically, when the acquisition part 232 of the vehicle control device 12 acquires data of the image shown in FIG. 3 as the image data generated by the monocular camera 2, the data of the image shown in FIG. 3 is input to the trained machine learning model. The trained machine learning model identifies and outputs the position and class “type: passenger vehicle” of the preceding vehicle VL included in the image shown in FIG. 3 reflecting, for example, the result of the machine learning using the teacher data image shown in FIG. 5 including the preceding vehicle for learning V3 and the annotation information (information “type: passenger vehicle” showing the type of the preceding vehicle for learning V3) added to the teacher data image.

Furthermore, the vehicle-to-vehicle distance estimation part 234 uses the trained machine learning model to estimate the vehicle-to-vehicle distance between the host vehicle 1 and preceding vehicle VL based on the image shown in FIG. 3. Specifically, the vehicle-to-vehicle distance estimation part 234 outputs the result of estimation “distance: close” showing that the vehicle-to-vehicle distance between the preceding vehicle VL included in the image shown in FIG. 3 and host vehicle 1 is shorter than the suitable vehicle-to-vehicle distance reflecting the result of the machine learning using, for example, the teacher data image shown in FIG. 5 including the preceding vehicle for learning V3 and the annotation information (information “distance: close” showing that the vehicle-to-vehicle distance between the vehicle for capturing teacher data images and the preceding vehicle for learning V3 is shorter than the suitable vehicle-to-vehicle distance) added to the teacher data image.

The vehicle control part 231 performs autonomous driving control of the host vehicle 1 based on the result of estimation “distance: close” output by the vehicle-to-vehicle distance estimation part 234. For example, the vehicle control part 231 performs the autonomous driving control of the host vehicle 1 (for example, makes the braking actuator 15 operate so as to make the host vehicle 1 decelerate) so that the vehicle-to-vehicle distance between the preceding vehicle VL and host vehicle 1 becomes longer up to the suitable vehicle-to-vehicle distance.

As a result, in the example shown in FIG. 3, there is no need to use a compound eye camera image or, for example, use the results of detection of the LiDAR 4 or other distance measurement sensor and it is possible to maintain the vehicle-to-vehicle distance between the host vehicle 1 and the preceding vehicle VL at the suitable vehicle-to-vehicle distance.

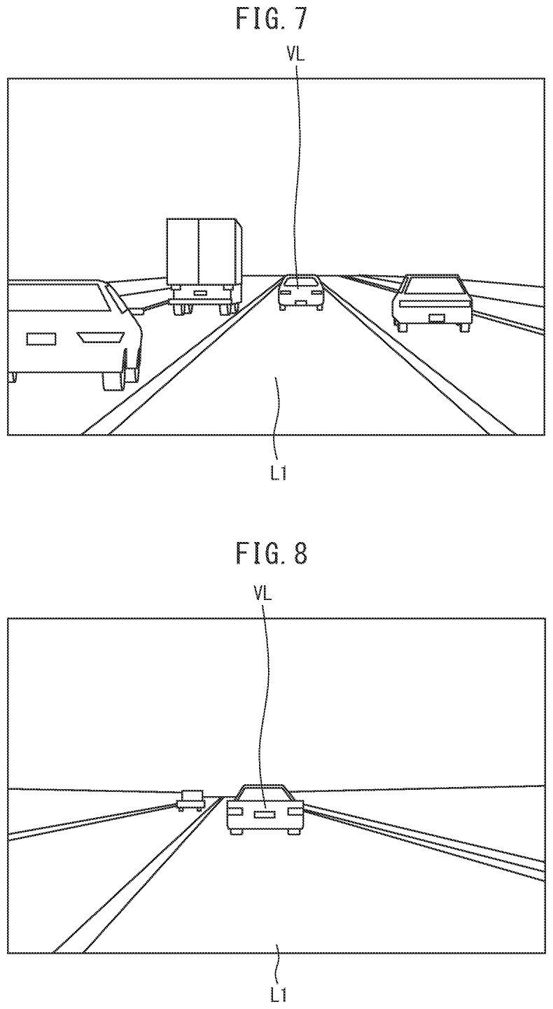

FIG. 7 shows another example of the image including the preceding vehicle VL etc. captured by the monocular camera 2 mounted on the host vehicle 1. In the example shown in FIG. 7, the preceding vehicle VL traveling in the same lane as the lane LI which the host vehicle 1 is traveling in etc. is included in the image captured by the monocular camera 2.

When the acquisition part 232 of the vehicle control device 12 acquires the data of the image shown in FIG. 7 as the image data generated by the monocular camera 2, the data of the image shown in FIG. 7 is input to the trained machine learning model. The trained machine learning model identifies and outputs the position and class “type: passenger vehicle” of the preceding vehicle VL included in the image shown in FIG. 7 reflecting, for example, the result of the machine learning using the teacher data image shown in FIG. 5 including the preceding vehicle for learning V6 and the annotation information (information “type: passenger vehicle” showing the type of the preceding vehicle for learning V6) added to the teacher data image.

Furthermore, the vehicle-to-vehicle distance estimation part 234 uses the trained machine learning model to estimate the vehicle-to-vehicle distance between the host vehicle 1 and preceding vehicle VL based on the image shown in FIG. 7. Specifically, the vehicle-to-vehicle distance estimation part 234 outputs the result of estimation “distance: far” showing that the vehicle-to-vehicle distance between the preceding vehicle VL included in the image shown in FIG. 7 and host vehicle 1 is longer than the suitable vehicle-to-vehicle distance reflecting the result of the machine learning using, for example, the teacher data image shown in FIG. 5 including the preceding vehicle for learning V6 and the annotation information (information “distance: far” showing that the vehicle-to-vehicle distance between the vehicle for capturing teacher data images and the preceding vehicle for learning V6 is longer than the suitable vehicle-to-vehicle distance) added to the teacher data image.

The vehicle control part 231 performs the autonomous driving control of the host vehicle 1 based on the result of estimation “distance: far” output by the vehicle-to-vehicle distance estimation part 234. For example, the vehicle control part 231 performs the autonomous driving control of the host vehicle 1 (for example, makes the drive actuator 15 operate so as to make the host vehicle 1 accelerate) so that the vehicle-to-vehicle distance between the preceding vehicle VL and host vehicle 1 becomes shorter down to the suitable vehicle-to-vehicle distance.

As a result, in the example shown in FIG. 7, there is no need to use the compound eye camera image or, for example, use the results of detection of the LiDAR 4 or other distance measurement sensor and it is possible to maintain the vehicle-to-vehicle distance between the host vehicle 1 and preceding vehicle VL at the suitable vehicle-to-vehicle distance.

In another example, when the result of estimation “distance: far” showing that the vehicle-to-vehicle distance between the preceding vehicle VL and host vehicle 1 is longer than the suitable vehicle-to-vehicle distance is output by the vehicle-to-vehicle distance estimation part 234, the vehicle control part 231 need not perform the autonomous driving control of the host vehicle 1 (for example, make the host vehicle 1 accelerate) so that the vehicle-to-vehicle distance between the preceding vehicle VL and host vehicle 1 becomes shorter down to the suitable vehicle-to-vehicle distance but may maintain the vehicle-to-vehicle distance between the preceding vehicle VL and host vehicle 1.

FIG. 8 shows still another example of the image including the preceding vehicle VL etc. captured by the monocular camera 2 mounted on the host vehicle 1. In the example shown in FIG. 8, the preceding vehicle VL traveling in the same lane as the lane LI which the host vehicle 1 is traveling in etc. is included in the image captured by the monocular camera 2.

When the acquisition part 232 of the vehicle control device 12 acquires the data of the image shown in FIG. 8 as the image data generated by the monocular camera 2, the data of the image shown in FIG. 8 is input to the trained machine learning model. The trained machine learning model identifies and outputs the position and class “type: passenger vehicle” of the preceding vehicle VL included in the image shown in FIG. 8 reflecting, for example, the result of the machine learning using the teacher data image shown in FIG. 6 including the preceding vehicle for learning V7 and the annotation information (information “type: passenger vehicle” showing the type of the preceding vehicle for learning V7) added to the teacher data image.

Furthermore, the vehicle-to-vehicle distance estimation part 234 uses the trained machine learning model to estimate the vehicle-to-vehicle distance between the host vehicle 1 and preceding vehicle VL based on the image shown in FIG. 8. Specifically, the vehicle-to-vehicle distance estimation part 234 outputs the result of estimation “distance: suitable” showing that the vehicle-to-vehicle distance between the preceding vehicle VL included in the image shown in FIG. 8 and host vehicle 1 is the suitable vehicle-to-vehicle distance reflecting the result of the machine learning using, for example, the teacher data image shown in FIG. 6 including the preceding vehicle for learning V7 and the annotation information (information “distance: suitable” showing that the vehicle-to-vehicle distance between the vehicle for capturing teacher data images and the preceding vehicle for learning V7 is the suitable vehicle-to-vehicle distance) added to the teacher data image.

The vehicle control part 231 performs the autonomous driving control of the host vehicle 1 based on the result of estimation “distance: suitable” output by the vehicle-to-vehicle distance estimation part 234. Specifically, the vehicle control part 231 performs the autonomous driving control of the host vehicle 1 so as to maintain the vehicle-to-vehicle distance between the preceding vehicle VL and host vehicle 1.

As a result, in the example shown in FIG. 8, there is no need to use the compound eye camera image or, for example, use the results of detection of the LiDAR 4 or other distance measurement sensor and it is possible to maintain the vehicle-to-vehicle distance between the host vehicle 1 and preceding vehicle VL at the suitable vehicle-to-vehicle distance.

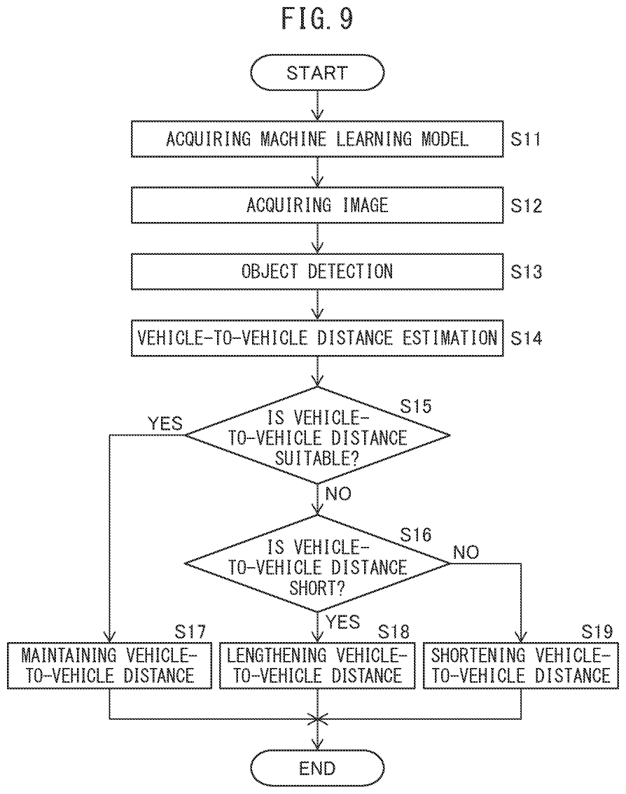

FIG. 9 is a flow chart for explaining one example of processing performed by the processor 23.

In the example shown in FIG. 9, at step S11, the vehicle control device 12, for example, acquires the trained machine learning model generated at the machine learning model generating server etc.

At step S12, the acquisition part 232 acquires the image data generated by the monocular camera 2.

At step S13, the object detection part 233 uses the trained machine learning module acquired at step S11 to perform the object recognition based on the image data acquired at step S12 (that is, identify the position and class (type) of the preceding vehicle VL included in the image shown by the image data acquired at step S12).

At step S14, the vehicle-to-vehicle distance estimation part 234 uses the trained machine learning model acquired at step S11 to estimate the vehicle-to-vehicle distance between the host vehicle 1 and the preceding vehicle VL based on the image data acquired at step S12 (that is, outputs the result of estimation showing any of the vehicle-to-vehicle distance between the host vehicle 1 and preceding vehicle VL being the suitable vehicle-to-vehicle distance, the vehicle-to-vehicle distance between the host vehicle 1 and preceding vehicle VL being shorter than the suitable vehicle-to-vehicle distance, and the vehicle-to-vehicle distance between the host vehicle 1 and preceding vehicle VL being longer than the suitable vehicle-to-vehicle distance).

At steps S15 to S19, the vehicle control part 231 performs the autonomous driving control of the host vehicle 1 based on the result of estimation of the vehicle-to-vehicle distance between the host vehicle 1 and preceding vehicle VL output at step S14.

Specifically, at step S15, for example, the vehicle control part 231 determines whether the vehicle-to-vehicle distance between the host vehicle 1 and preceding vehicle VL estimated at step S14 is the suitable vehicle-to-vehicle distance. If YES, the routine proceeds to step S17, while if NO, it proceeds to step S16.

At step S16, for example, the vehicle control part 231 determines whether the vehicle-to-vehicle distance between the host vehicle 1 and preceding vehicle VL estimated at step S14 is shorter than the suitable vehicle-to-vehicle distance. If YES, it proceeds to step S18, while if NO, it proceeds to step S19.

At step S17, the vehicle control part 231 performs the autonomous driving control of the host vehicle 1 so as to maintain the vehicle-to-vehicle distance between the preceding vehicle VL and host vehicle 1.

At step S18, the vehicle control part 231 performs the autonomous driving control of the host vehicle 1 so that the vehicle-to-vehicle distance between the preceding vehicle VL and host vehicle 1 becomes longer up to the suitable vehicle-to-vehicle distance.

At step S19, the vehicle control part 231 performs the autonomous driving control of the host vehicle 1 so that the vehicle-to-vehicle distance between the preceding vehicle VL and host vehicle 1 becomes shorter down to the suitable vehicle-to-vehicle distance.

As explained above, in the host vehicle 1 in which the vehicle control device 12 of the first embodiment is applied, there is no need to accurately measure the vehicle-to-vehicle distance between the preceding vehicle VL and host vehicle 1 by using the compound eye camera image or, for example, using the results of detection of the LiDAR 4 or other distance measurement sensor. The vehicle-to-vehicle distance estimation part 234 can classify and estimate the vehicle-to-vehicle distance between the preceding vehicle VL and host vehicle 1 into three ways: “close”, “suitable”, and “far” (that is, estimate in the same way as the human senses). Due to this, the vehicle control part 231 can perform the autonomous driving control of the host vehicle 1 so that the vehicle-to-vehicle distance between the preceding vehicle VL and host vehicle 1 becomes the suitable vehicle-to-vehicle distance (that is, safe feeling vehicle-to-vehicle distance).

### Second Embodiment

As explained above, in the host vehicle 1 to which the vehicle control device 12 of the first embodiment is applied, the trained machine learning model stored in the memory 22 is not updated. On the other hand, in a host vehicle 1 to which the vehicle control device 12 of the second embodiment is applied, the trained machine learning model stored in the memory 22 may be updated.

In the vehicle control device 12 of the second embodiment, in the example shown in FIG. 3, the vehicle-to-vehicle distance estimation part 234 outputs the results of estimation “distance: close” showing that the vehicle-to-vehicle distance between the preceding vehicle VL included in the image shown in FIG. 3 and the host vehicle 1 is shorter than the suitable vehicle-to-vehicle distance, the vehicle control part 231 performs the autonomous driving control of the host vehicle 1 so that the vehicle-to-vehicle distance between the preceding vehicle VL and host vehicle 1 becomes longer up to the suitable vehicle-to-vehicle distance, then, if the driver of the host vehicle 1 does not perform an operation contrary to control of the vehicle control part 231 to shorten the vehicle-to-vehicle distance between the preceding vehicle VL and host vehicle 1, the image shown in FIG. 3 is added as the teacher data image, the result of estimation “distance: close” of the vehicle-to-vehicle distance estimation part 234 is added as the annotation information, and the trained machine learning model is updated.

Further, in the vehicle control device 12 of the second embodiment, in the example shown in FIG. 7, the vehicle-to-vehicle distance estimation part 234 outputs the results of estimation “distance: far” showing that the vehicle-to-vehicle distance between the preceding vehicle VL included in the image shown in FIG. 7 and the host vehicle 1 is longer than the suitable vehicle-to-vehicle distance, the vehicle control part 231 performs the autonomous driving control of the host vehicle 1 so that the vehicle-to-vehicle distance between the preceding vehicle VL and host vehicle 1 becomes shorter down to the suitable vehicle-to-vehicle distance, then, if the driver of the host vehicle 1 does not perform the operation contrary to control of the vehicle control part 231 to lengthen the vehicle-to-vehicle distance between the preceding vehicle VL and host vehicle 1, the image shown in FIG. 7 is added as the teacher data image, the result of estimation “distance: far” of the vehicle-to-vehicle distance estimation part 234 is added as the annotation information, and the trained machine learning model is updated.

Further, in the vehicle control device 12 of the second embodiment, in the example shown in FIG. 8, the vehicle-to-vehicle distance estimation part 234 outputs the results of estimation “distance: suitable” showing that the vehicle-to-vehicle distance between the preceding vehicle VL included in the image shown in FIG. 8 and the host vehicle 1 is the suitable vehicle-to-vehicle distance, the vehicle control part 231 performs the autonomous driving control of the host vehicle 1 so as to maintain the vehicle-to-vehicle distance between the preceding vehicle VL and host vehicle 1, then, if the driver of the host vehicle 1 does not perform the operation contrary to control of the vehicle control part 231 to change the vehicle-to-vehicle distance between the preceding vehicle VL and host vehicle 1, the image shown in FIG. 8 is added as the teacher data image, the result of estimation “distance: suitable” of the vehicle-to-vehicle distance estimation part 234 is added as the annotation information, and the trained machine learning model is updated.

In the above way, embodiments of the vehicle control device, the vehicle control method, and the non-transitory recording medium of the present disclosure were explained referring to the drawings, but the vehicle control device, the vehicle control method, and the non-transitory recording medium of the present disclosure are not limited to the above-mentioned embodiments and can be suitably changed in a range not deviating from the gist of the present disclosure. The configurations of the examples of the embodiments explained above may also be suitably combined.

In the examples of the above-mentioned embodiments, the processing performed in the vehicle control device 12 (the autonomous driving ECU) was explained as software processing performed by executing the program stored in the memory 22, but the processing performed in the vehicle control device 12 may also be processing performed by hardware. Alternatively, the processing performed in the vehicle control device 12 may also be processing combining both software and hardware. Further, the program stored in the memory 22 of the vehicle control device 12 (program realizing functions of the processor 23 of the vehicle control device 12) may also, for example, be provided, distributed, etc. by recorded in a semiconductor memory, magnetic recording medium, optical recording medium or other such computer readable storage medium (non-transitory recording medium).

1. A vehicle control device comprising a processor configured to:
perform autonomous driving control of a host vehicle; and
estimate a vehicle-to-vehicle distance of the host vehicle and a preceding vehicle by using machine learning model based on an image including the preceding vehicle captured by a monocular camera mounted on the host vehicle, wherein
the machine learning model is generated by performing machine learning using teacher data images including a preceding vehicle for learning captured from a vehicle for capturing teacher data images and annotation information added to the teacher data images,
the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance,
the processor is configured to output result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance, and
perform the autonomous driving control of the host vehicle based on the result of estimation.

2. The vehicle control device according to claim 1, wherein the processor is configured to perform the autonomous driving control of the host vehicle so that the vehicle-to-vehicle distance of the host vehicle and the preceding vehicle becomes longer up to the suitable vehicle-to-vehicle distance when the result of estimation showing the vehicle-to-vehicle distance of the host vehicle and the preceding vehicle is shorter than the suitable vehicle-to-vehicle distance is output and the processor is configured to perform the autonomous driving control of the host vehicle so that the vehicle-to-vehicle distance of the host vehicle and the preceding vehicle becomes shorter down to the suitable vehicle-to-vehicle distance when the result of estimation showing the vehicle-to-vehicle distance of the host vehicle and the preceding vehicle is longer than the suitable vehicle-to-vehicle distance is output.

3. The vehicle control device according to claim 1, wherein
the preceding vehicle is traveling in the same lane as a lane which the host vehicle is traveling in, and
the preceding vehicle for learning includes a vehicle traveling in a different lane from a lane which the vehicle for capturing the teacher data images is traveling in.

4. The vehicle control device according to claim 1, wherein
the annotation information includes information showing a type of the preceding vehicle for learning, and
the annotation information is added to a teacher data image when annotation of the teacher data image is performed.

5. A vehicle control method comprising:
performing autonomous driving control of a host vehicle; and
estimating a vehicle-to-vehicle distance of the host vehicle and a preceding vehicle by using machine learning model based on an image including the preceding vehicle captured by a monocular camera mounted on the host vehicle, wherein
the machine learning model is generated by performing machine learning using teacher data images including a preceding vehicle for learning captured from a vehicle for capturing teacher data images and annotation information added to the teacher data images,
the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance,
in estimation of the vehicle-to-vehicle distance of the host vehicle and the preceding vehicle, result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance is output, and
the autonomous driving control of the host vehicle is performed based on the result of estimation output in the estimation of the vehicle-to-vehicle distance of the host vehicle and the preceding vehicle.

6. A non-transitory recording medium having recorded thereon a computer program for causing a processor to execute a process comprising:
performing autonomous driving control of a host vehicle; and
estimating a vehicle-to-vehicle distance of the host vehicle and a preceding vehicle by using machine learning model based on an image including the preceding vehicle captured by a monocular camera mounted on the host vehicle, wherein
the machine learning model is generated by performing machine learning using teacher data images including a preceding vehicle for learning captured from a vehicle for capturing teacher data images and annotation information added to the teacher data images,
the annotation information includes information showing any of the vehicle-to-vehicle distance between the vehicle for capturing the teacher data images and the preceding vehicle for learning being a suitable vehicle-to-vehicle distance, the vehicle-to-vehicle distance between the vehicle for capturing the teacher data images and the preceding vehicle for learning being shorter than the suitable vehicle-to-vehicle distance, and the vehicle-to-vehicle distance between the vehicle for capturing the teacher data images and the preceding vehicle for learning being longer than the suitable vehicle-to-vehicle distance,
in estimation of the vehicle-to-vehicle distance of the host vehicle and the preceding vehicle, result of estimation showing any of the vehicle-to-vehicle distance of the host vehicle and the preceding vehicle being the suitable vehicle-to-vehicle distance, the vehicle-to-vehicle distance of the host vehicle and the preceding vehicle being shorter than the suitable vehicle-to-vehicle distance, and the vehicle-to-vehicle distance of the host vehicle and the preceding vehicle being longer than the suitable vehicle-to-vehicle distance is output, and
the autonomous driving control of the host vehicle is performed based on the result of estimation output in the estimation of the vehicle-to-vehicle distance of the host vehicle and the preceding vehicle.
